(19) United States
(12) Patent Application Publication
(10) Pub. No.: US 2003/0112808 A1
(43) Pub. Date: Jun. 19, 2003

(54) Automatic configuration of IP tunnels

(75) Inventor: Ronen Solomon, Givatayim (IL)

Correspondence Address: BROMBERG & SUNSTEIN LLP, 125 SUMMER STREET, BOSTON, MA, 02110-1618, US

(73) Assignee: NET REALITY LTD, Petach Tikva (IL)

(21) Appl. No.: 10/013,835

(22) Filed: Dec. 13, 2001

(51) Int. Cl. H04L 12/28; H04L 12/56

(52) U.S. Cl. 370/400; 370/392; 370/395.52

(57) ABSTRACT

A method and means for automatically detecting, for any site or LAN of an organizational net, all the external subnets within the net with which it, or any subnet within it, actively communicate through a WAN and compiling a configuration- or mapping table that lists address pairs of such detected subnets as corresponding active tunnels. The process, carried out by a special agent, includes intercepting data packets flowing in- or out of the LAN and extracting from each the local and remote subnet addresses. Further the table is to indicate, for each such tunnel, an IP address associated with the LAN to which the remote subnet is connected. Such an address is obtained by sending in inquiry message to the remote subnet, which is intercepted by the corresponding remote agent, and having the remote agent send a response message to the originating agent, from which the remote agent's address is extracted. Other data may also be exchanged between the agents in the net, including data in the compiled tables. The data in the tables subsequently serve to classify data traffic as to the tunnel through which each data packet flows and as to services to be applied to these data.

### FIELD OF THE INVENTION

This invention relates to organizational communication over a large IP-based network and, particularly, to automatic configuration of tunnels among sites and subnet within an organization, based on detection of traffic topology.

### BACKGROUND OF THE INVENTION

Large organizations are usually spread over a plurality of geographic sites. There is generally at each site one or more local area networks (LANs) which serve exclusively to interconnect host units (including servers, workstations, etc.) located there. Each LAN may be realized by any communication technology, including such based on wires, optical fibers and wireless technologies, and may consist of one or more segments, joined by routers or bridges, each segment connecting a plurality of hosts. Communication with other sites is usually carried out over a Wide-Area Network (WAN), sometimes also over a so-called Metro Area Network a geographically extended LAN, a Wireless Network or any combination of such networks (to be collectively referred to in the sequel as a WAN). This may constitute a private network, but is more generally realized over a public, or open, network—meaning that other organizations or individuals have access to it and use it for their communication needs. In some cases, a so-called virtual private network (VPN) is formed over a public network and dedicated to exclusive access by the organization. The invention is directed at the prevalent class of LANs and of WANs, whether private, VPN or public, that is based on the Internet Protocol (IP) for level-3 communication and addressing, though it could be applied also to other, similarly structured, networks. A common example of a public IP-based WAN is the global Internet. Each local network of the organization is connected to a node of the WAN, generally through a gateway- or edge-router (to be referred to simply as the router) or through a switch; in case of a public WAN, the node is usually provided by a service provider, there being a direct communication path between the router and the node. Generally, any node may be thus connected to a plurality of LANs—each through a respective router or switch.

In the IP addressing scheme, each host has a unique address. An IP address consists of 32 bits, grouped into four eight-bit bytes, which are commonly Fatten as corresponding four decimal numbers, separated by points. An IP address is, in general, logically divided into three fields—network field, subnet field and host field The network field consists of one, two or three leftmost bytes corresponding, respectively, to a class A, class B or class C address. The subnet field of the address, which is optional, consists of any number, n (between I and a maximum of 7, 15 or 23—depending on whether the class is type C, B or A, respectively), of the leftmost of the remaining bits. The host field consists of the remaining rightmost bits. The three classes are distinguished by the value ranges of the first (leftmost) byte, namely: Values 1-127 are for Class A addresses (allowing 127 networks, with a total of 255×255×255 hosts each); Values 128-191 are for Class B addresses (allowing 63×255 networks, with a total of 255×255 hosts each); And values 192-223 are for Class C addresses (allowing 32×255×255 networks, with a total of 255 hosts each).

Subnetting enables the customer having a class A, B or C address to increase the number of available network addresses, whereby each such two-fields network address now refers to a subnet. Obviously, the number of host addresses available to each subnet is then proportionally smaller. An example of the complete address structure, for the case of a class-C (three bytes) network address, with eight subnets (requiring three high-order bits of the last byte), is shown in FIG. 1; in this case each subnet can have 32 hosts. The fill address of any subnet is the concatenation of the network field and the subnet field, which contains 8+n (Class A subnetting), 16+n (Class B subnetting) or 24+n bits (Class C subnetting), according to the IP address schema. To extract the subnet address from any full IP address, the latter is masked by a mask, whose 8+n, 16+n or 24+n leftmost bits (for class A, B, or C addresses, respectively) are “I”. Such a mask, which in effect specifies the number of bits allocated to the entire (double-fielded) network portion of the address, defines a group of 2ˆ n (2 to the power n) subnet addresses, or address range, with a common network address field. A mask is commonly written either as the number of 1's it contains or as four decimal numbers (similar to an IP address in a “dot notation”).

It is noted that, in general, the network field of the address does not necessarily correspond to any physical network or part thereof, nor even to a logical net (the latter concept being explained Per below), but rather serves to define a range of host addresses that is assignable to an organization. Furthermore, any such network address may be logically divided into a group of subnet addresses, as explained above—either by the organization or by the service provider (who assigns the network addresses). Each distinct subnet address (including the case of a null subnet, which has only the network address field, i.e. n=0), is normally associated with a particular LAN; however, different subnets that share a common network address may, generally, be assigned to several LANs (even at different sites). Usually, all hosts that are connected to any one LAN and that organizationally form a group (also referred to as a subnetwork) share a unique subnet address. Any one LAN may (and usually does) contain several subnets; that is, hosts connected to the LAN may be grouped into several subnets, with corresponding subnet addresses.

Within IP layer 3, data are sent as packets, each packet containing a source address (referring to the host that originated the data) and a destination address (namely that of the host intended to receive the data). A router through which the packet passes generally examines the network portion of the destination address, compares it with a routing table stored therein and sends the packet accordingly to the next appropriate node in the WAN (Next hop). When the network address also includes a subnet field, the corresponding subnet addresses must also appear in the table, so that the appropriately masked destination address can be compared for routing.

An organizational IP-based communication system consists of a plurality of hosts, interconnected at each site by a LAN and the sites being interconnected through a WAN. Since all the hosts in the organization have known unique IP addresses, they may collectively be regarded as forming a logical net. This logical net is usually divided according to the organizational structure—in terms of locations and functions (e.g. departments). The smallest unit of this division, consisting of a group of hosts (possibly only a single host) at a particular site, is usually referred to as a subnet and each such unit is assigned, in common, a unique IP network or subnet address, as explained above. In the sequel, any such address, whether or not it includes a subnet field, will be referred to as a subnet address.

An organization is assigned by the service provider (in the case of a public WAN) or by the network administrator (in a private WAN), one or more particular IP networks- and/or subnet addresses, of any one or more classes, according to the organization's needs, that is—according to the total number of hosts it plans to have within its net and so as to match the subnet requirements of the organizational net structure, as discussed above. Subnet addresses are given as a mask (or, equivalently, as the subnet range or field size) corresponding to the respective network address. The organization may also choose to split any of the assigned network addresses into subnet addresses, by devising an appropriate subnet mask (which defines tie range of the subnet addresses). The totality of network addresses and subnet masks thus assigned is known as the address configuration of the organizational net.

An illustrative example of an address configuration, having subnet address ranges associated with three exemplary assigned network addresses, each of a different class, is Shown in the table of FIG. 2. Subnet addresses from the thus created ranges (as well as complete network addresses, where appropriate) are uniquely assigned to the various subnets defined in each of the sites of the organization. Usually there will be several subnets at any one site and each host belonging to any one subnet will be assigned an IP address that corresponds to its logical subnet within the local organization (and, of course, its own unique host address field). The table of FIG. 3 illustrates, by way of a very simplified example, the assignment of seven of the subnet addresses of FIG. 2 to four sites. It is noted that there is no logical relation between any particular subnet address and the site to which it is assigned; thus, different subnet addresses based on the same network address may be assigned to different sites and, conversely, any one site may be assigned subnet addresses based on different network addresses—even of different classes.

The totality of the IP addresses thus assigned within an organization in effect forms a logical net, whereby any host can potentially communicate with any other host in the organization. However, while communication within any site is physically separate from anything outside it and communication within any subnet can be logically separated from the outside, there is nothing that a priori distinguishes communications among the hosts in the net from communication with any host outside it that shares the WAN. Therefore, the communication among the various LANs of an organization, when carried over a public or multi-organizations WAN, is often given some degree of isolation from the rest of the users, so as to make it appear to be, or behave like, a private WAN. Such an arrangement is known as a virtual private network (VPN) and generally entails access control and encryption. These functions operate at the IP level (layer 3); typically, encryption is in terms of a security protocol, such as the widely used IP-Sec The VPN configuration may also be realized by the service provider or by the organization at a lower layer, through appropriate modification of the edge router or the provision of a suitable separate customer premises equipment (CPE) along the connection path between each LAN and the corresponding node of the WAN. Another, quite convenient, layer-2 alternative is to employ the Multi-Protocol Label Switching (MPLS) protocol.

The communication path between any pair of sites (or LANs) within an organization is known as an IP tunnel. A VPN may be configured as a whole—in effect providing a tunnel from any node to any node (“any-to-any” tunneling), or it may be configured by defining specific tunnels. The former alternative makes the control and charcterization of individual tunnels rather cumbersome, especially in the case of a large organization that includes numerous sites and LANs. In very large organizations, even the configuration of only the defined tunnels may be cumbersome, especially if the definition is dynamic, i.e. changing with time and with organizational needs and structure. The concept of tunnels is particularly useful in conjunction with various operations and services that are provided differentially to various tunnels, as will be explained below. Very often it is desired to differentiate services provided between pairs of subnets, rather than just between sites or LANs; it would then be desirable to also define tunnels between such subnets. Obviously, the number of such tunnels in a typical organization would be considerably larger than those definable only between LANs, and therefore their configuration would be enormously more cumbersome.

The system diagram of FIG. 4 illustrates the relation between sites, WAN, LANs and subnets in a simplified example of an organizational net, corresponding to that of FIG. 3. The structure of this example will be explained below, in conjunction with the method of the invention, with reference to FIG. 5, which shows an identical system, modified according to the invention. It is noted that in the example of FIGS. 4 and 5, each LAN is connected to a different node in the WAN; in general, however, several LANs may be connected to the same node.

There is often a need to provide additional services (which are also referred to as operations or functions) to communication among the sites of the organization; these are usually provided differentially between pairs of sites and hopefully also between pairs of subnets, and this is the main reason for defying and configuring tunnels. These services, which may be provided by appropriate units within common or dedicated network components (such as CPE modules) may typically include:

the function of a Channel—or Digital Service Unit (CSU/DSU—for private WAN),

traffic monitoring and analysis,

Quality Of Service/Traffic Shaping,

encryption and/or compression,

IP Service Level Agreement (SLA) monitoring,

tunnel response-time measurement, etc.

Some of these functions require measurements at both a sending and a receiving node. These services are typically provided at customer premises equipment (CPE), located between any LAN and the corresponding node or at some other component of the LAN or the WAN that handles the particular LAN's outside traffic.

Configuration of tunnels usually involves a configuration table for each LAN, listing for all the relevant tunnels the associations between the addresses of the local network (and hopefully also its subnets) and those of the remote networks (and, hopefully, subnets). In order for a CPE module, or any other network component, to apply services differentially to tunnels, the configuration table needs to also include the addresses of the corresponding remote components (or to otherwise identify them). Compiling such a configuration table is generally tedious—especially for a large organization, with many sites and, particularly, many subnets. It is tedious not only because of the effort required when collecting all system-wide relevant IP addresses during initial compilation, but also because the table has to be continuously maintained in face of organizational changes and the resulting changes in the configuration of networks and subnets. It is noted that this effort has to be repeated for every component that provides such service, at each site of the system. It is further noted that such components are usually provided independently of the network equipment, by a vendor who is generally not cognizant of the organizational structure and tie corresponding layout of the net; he therefore would need to obtain the information from the organizational network manager, whereby there would be no guarantee for its integrity or its being up-to-date, Furthermore, because the service often requires intervention by the appropriate component at the other (remote) site, it is imperative that the identity of such a remote component i.e. its IP address, be known to the local service providing component, so as to establish communication therebetween for the purpose of coordination, exchanging parameters or ascertaining operability. Such identities must therefore be part of the configuration table, as indicated above. Obtaining this information manually is, again, a tedious task. On the other hand, obtaining it from the network (e.g. from routers en route), although theoretically possible, is often not practical, because of lack of interoperability between the service modules and the regular network components (e.g routers) and because the required access may not be granted, owing to security or propriety considerations.

There is thus a need for a tunnels configuration table at each site that associates local subnets with remote subnets and with remote service providing modules. There may also be other reasons and purposes for such a configuration table. It is observed, on the other hand, that in a typical organizational net, the message traffic tends to confine itself to paths between only certain pairs of sites or subnets. It is indeed for such pairs that the concept of tunnels is particularly applicable and for which particular net services are intended. Tunnels between such pairs will be referred to as active tunnels. It is further observed that generally not all subnet addresses within the defined ranges are actually assigned at any particular time and that of those assigned, not all are actually used in any communication traffic. All subnets that do participate in communication will be referred to as active subnets. In view of these observations, it seems that predefining tunnels for all conceivable LAN pairs, and certainly of all conceivable subnet pairs, and the compilation of suitable configuration tables is unnecessary and wasteful. It is therefore desirable, and would be highly useful, to have a method for automatically compiling and maintaining configuration tables of IP tunnels within an organization. It would be further desirable and useful if such compilation and maintaining will be with respect to active tunnels only, by singling out, for any CPE or other network component, only those IP addresses with which the local network or subnets actively communicate (i.e. active subnets).

### SUMMARY OF TEE INVENTION

The invention basically provides a method for automatically compiling, for any site or LAN of an organizational net, a configuration- or mapping table of all the external subnets within the net with which it, or any subnet within it, actively communicates through the WAN. Each such table is associated with a particular LAN, which constitutes a local LAN with respect to that table (and the process of compiling it); all other LANs constitute remote LANs with respect to that table. Accordingly, subnets within a local LAN constitute local subnets and subnets within a remote LAN constitute remote subnets. Each table is thus to list which combinations of a local subnet and a remote subnet are active, that is—which pairs form active tunnels; preferably it should also indicate what services should be provided for each tunnel. Further the table is to indicate, for each such tunnel, the IP address of the corresponding remote network component that participates in providing the service; in effect, this also identifies the corresponding remote site. Optionally, the table is made to completely map all active subnets in the entire net, classified to their respective sites. The method essentially constitutes automatic detection and mapping of traffic flow topology; accordingly, it will be termed Traffic Flow Topology Mapping (TFM) and the resulting table—Traffic Topology Map (TTM). Likewise, any hardware or software module (residing in, or constituting all or part of a CPE or of another network component) that is configured according to the invention to carry out the method will be termed Traffic Topology Mapping Agent (TTMA) hereafter, Optionally it may be packaged with modules of other functionalities—notably such that carry out one or more of the tunnel-related services. A TTMA according to the invention may be regarded as a particular kind of a network agent, other kinds of which are known in the art.

Compilation of a TTM associated with any LAN, according to the method of the invention is basically carried out in two phases, which may be applied alternatingly. The first phase involves monitoring packet traffic flowing between the LAN and the WAN and noting the source- and destination subnet addresses. This is done by masking each (source- or destination-) fill IP address with the appropriate mask that defines the range of subnet addresses. During that first stage, the TTMA lists (a) all active local subnets, by thus noting the destination addresses in incoming packets and source addresses in outgoing packets, and (b) all remote subnets with which there has been communication—by thus noting source addresses of incoming packets and destination addresses of outgoing packets.

During the second phase, which may be initiated periodically, the TTMA sends a special exploration packet to any host in a remote subnet newly listed. The packet, having a special format termed IP Tunnel Control Protocol (ITCP), contains the IP address of the sending TTMA and optionally also the list of all active local subnets. Each remote TTMA, upon intercepting such a packet copies the list (if included in the message) to a remote TTM (which is local with respect to itself), in association with the address of the sending TTMA. It then sends a similar packet, containing its own address and optionally a list of its own associated local active subnets, to the sending TTMA. The latter then fills in the address of the remote TTMA in association with the newly listed subnet address, as well as with each remote subnet that appears in the received list (if included in the message).

Each TTMA thus compiles, for the LAN with which it is associated (or for each such LAN, if more than one), a TTM, which is a comprehensive mapping table, in which all pairs of subnet addresses between which there has been active communication are listed as indexed tunnels, in association with the addresses of corresponding remote TTMAs. Optionally, also assigned services (such as encryption or compression), are registered in association with each tunnel. Alternatively, the indices in the table may serve as a basis for associating certain services with particular tunnels by means of suitable separate tables (usually resident at the corresponding service providing components). Entering such information may have to be done by an operator—human or a suitably programmed agent, on the basis of rules appropriate to the organization and its various sites. Preferably, the TTM is formatted as a Management Information Base (MIB), commonly known in the art.

Once a TTM has been compiled, the source- and destination addresses of every packet in or out of the associated LAN are monitored and if both of them match an entry in the table, the packet is classified as belonging to the net and, if so—to a particular tunnel, and a corresponding service is possibly applied. Optionally, the TTMA itself may be programmed to also provide such monitoring and classification functions or, alternatively, packaged together with an agent providing these functions.

The TTMA automatically updates the TTM, by continuously running the first phase of the TFTM procedure and periodically—the second phase, as outlined above. During such updating, tunnels for which no active communication has been detected for a certain period may be removed, according to an aging timer for each entry in the mapping table. Optionally, the routinely monitored traffic is statistically analyzed, to identify tunnels that have become inactive, and these may be deleted from the table.

Specifically, the invention provides for an organizational communication net, based on the internet Protocol (IP) and deployed over a plurality of Local-Area Networks (LANs) that are interconnected by a Wide-Area Network (WAN); each LAN is associated with at least one IP LAN address and connected to at least one host the hosts being grouped into one or more subnets, each subnet sharing a unique network- or subnet address, which is within the range of a given organization-wide network address configuration; the communication path between any host having any particular subnet address and any host having any other particular subnet address and connected to a different LAN is termed a tunnel a method for automatically compiling a dynamic traffic topology map (TTM) for each of a plurality of LANs, the method comprising the following steps executed with respect to any one of the LANs, constituting a local LAN:

(a) automatically detecting the respective subnet addresses of a local host and of a remote host between which any data packets flow, the addresses being a local subnet address and a remote subnet address, respectively;

(b) automatically obtaining a LAN address of a remote LAN that is connected to the host having the remote subnet address and associating the obtained LAN address with the remote subnet address;

(c) registering a tunnel for the combination of the local subnet address and the remote subnet address, if not presently registered, the registration including recording the local and remote subnet addresses and the remote LAN address obtained in step b;

(d) repeating steps a, b and c multiple times; the totality of registered tunnels form the TTM.

More specifically, step a includes:

(i) intercepting any of the packets and parsing it into a source IP address (SIP) and a destination IP address (IP);

(ii) comparing each of the addresses of step i with the given organization-wide address configuration and thereby extracting a corresponding subnet address;

(iii) if the intercepted packet is outgoing, recording the subnet address extracted from the SIP as a local subnet address and that extracted from the DIP—as a remote subnet address; and if the intercepted packet is incoming, recording the subnet address extracted from the DIP as a local subnet address and that extracted from the SIP—as a remote subnet address.

Also more specifically, step b includes:

(iv) sending from a network component associated with the local LAN, constituting a local component, an inquiry message addressed to any host having the remote subnet address, the message including a local LAN address, which is the LAN address of the local component;

(v) intercepting the inquiry message by a network component associated with the LAN to which the any host is connected, it being a remote component, and extracting the local LAN address from the inquiry message;

(vi) sending a response message from the remote component, addressed to the local component and including a remote LAN address, which is the LAN address of the remote component;

(vii) receiving the response message at the local component and extracting therefrom the remote LAN address.

According to further features of the invention, the inquiry message also includes one or more local subnet addresses and substep v flier includes having the local subnet addresses extracted from the intercepted message and associated to with the extracted local LAN address; and the response message also includes one or more remote subnet addresses and substep vii further includes having the remote subnet addresses extracted from the received message and associated with the extracted remote LAN address.

According to other features of the invention, the only data input from outside the system is the organizational address configuration, the data being identically fed with respect to al LANs within the net. Also, all steps of the method are performed at each of the network components by an agent residing therein and wherein a plurality of the agents cooperate in performing any of the steps.

According to optional features, the method of the invention her includes associating with each registered towel one or more specific services applicable to it or to data packets flowing through it, and, further—recording in any entry in the TTM the identities of services associated with the corresponding tunnel.

According to another optional feature, the method of the invention further includes classifying each packet flowing in or out of a LAN as to the tunnel in which it flows and preferably, applying to the packet any of the services that are associated with that tunnel According to yet another optional feature, the method of the invention further includes deleting from the TTM any tunnel through which no data packets have flowed over a preceding period of a given duration.

In another configuration of the invention, aimed at classifying, by tunnels, IP data packets flowing into and/or out of any one LAN, to be considered a local LAN, from and/or to other LANs, to be considered remote LANs, the method comprises:

(a) providing structure for a traffic topology map (TTM), associated with the local LAN, in which tunnels may be registered, the structure including an entry corresponding to each registered tunnel, each entry including a local subnet address, which is the address of a subnet in the local LAN, and a remote subnet address, which is the address of a subnet in the remote LAN;

(b) intercepting any of the packets and extracting therefrom a local subnet address and a remote subnet address;

(c) comparing the extracted pair of addresses with corresponding pairs in any tunnels registered in the TTM;

(d) if the comparison results in a match, associating the packet with the corresponding tunnel;

(e) if the comparison results in no match, registering the extracted pair in the TTM as a new tunnel.

In a further configuration of the invention, aimed at automatically registering local subnets, the method comprises:

(a) intercepting a packet flowing into, or out of, the LAN and parsing it into a source IP address (SIP) and a destination IP address (DIP);

(b) comparing each of the addresses of step a with the given organization-wide address configuration and thereby extracting a corresponding subnet address;

(c) if the intercepted packet is outgoing, recording the subnet address extracted from the SIP as a local subnet address and if the intercepted packet is incoming, recording the subnet address extracted from the DIP as a local subnet address.

In yet another configuration of the invention, aimed at automatically obtaining, for any remote subnet address registered in association with a local LAN, a LAN address associated with the remote LAN that is connected to the respective subnet, the obtained address to be associated with the registered subnet address, the method comprises:

(a) sending from a network component associated with the local LAN, constituting a, local component, an inquiry message addressed to any host having the remote subnet address, the message including a local LAN address, which is the LAN address of the local component;

(b) intercepting the inquiry message by a network component associated with the LAN to which the any host is connected, it being a remote component, and extracting the local LAN address from the inquiry message;

(c) sending a response message from the remote component, addressed to the local component and including a remote LAN address, which is the LAN address of the remote component;

(d) receiving the response message at the local component and extracting therefrom the remote LAN address.

In a still further configuration of the invention, aimed at automatically compiling, with respect to any LAN, considered as a local LAN, a traffic topology map (TTM) of active tunnels between local hosts, connected to the local LAN, and remote hosts, connected to remote LANs, the method comprises:

(a) automatically detecting a subnet addresses of any local host and of any remote host between which any data packet flows, the addresses being a local subnet address and a remote subnet address, respectively;

(b) registering a tunnel for the combination of a local subnet address and a remote subnet address detected in step a, if not presently registered;

(c) repeating steps a and b multiple times; the totality of registered tunnels form the TTM.

In another aspect of the invention there is provided for an organizational communication net based on the Internet Protocol (IP) and deployed over a plurality of Local-Area Networks (LANs) that are interconnected by a Wide-Area Network (WAN); each LAN is associated with at least one IP LAN address and connected to at least one host, the hosts being grouped into one or more subnets, each subnet sharing a unique network- or subnet address, which is within the range of a given organization-wide network address configuration; the communication path between any host having any particular subnet address and any host having any other particular subnet address and connected to a different LAN constitutes a tunnel and, furthermore, a tunnel over which any data packets have flowed over a given period of time constitutes an active tunnel—

a network component, connected to, or communicative with, any one or more of the LANs, each constituting a local LAN, the network component comprising a traffic topology mapping agent (TTMA) and one or more traffic topology maps (TTM), each TTM associated with a respective local LAN, wherein:

each TTM is a table structured as indexed entries, each entry corresponding to an active tunnel and including a local subnet address, a remote subnet address and a remote LAN address with which the remote subnet address is associated; and

the TTMA is a network agent operative to register active tunnels in each of the TTMs and, with respect to any of the tunnels to be registered, to—

automatically detect a subnet address of any host connected to the corresponding local LAN and a subnet address of any host connected to any other LAN, between which hosts any data packets flow, and record the two detected addresses in the respective entry of the corresponding TIM, as the local subnet address and the remote subnet address, respectively; and—

automatically obtain a LAN address associated with the other LAN and record the obtained LAN address in the respective entry of the corresponding TTM.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic representation of the structure of an IP address.

FIG. 2 shows an example of an IP address subnetting scheme.

FIG. 3 shows an example of assignment of subnet addresses to local nets (sites) of a hypothetical organization.

FIG. 4 is a diagram of an exemplary net topology of the hypothetical organization of FIG. 3.

FIG. 5 is a diagram similar to that of FIG. 4, showing positions of LIMA modules according to the invention

FIG. 6 is a flow chart of the operation according to the method of the invention.

FIG. 7 shows an example of a TTM table compiled during a first phase of the operation of Pig. 6.

FIG. 8 is a schematic diagram of the second phase of operation according to the method of the invention.

FIG. 9 shows the TTM table of FIG. 7 after the operation of FIG. 8.

FIG. 10 is a schematic representation of the structure of an ITCP message according to the invention.

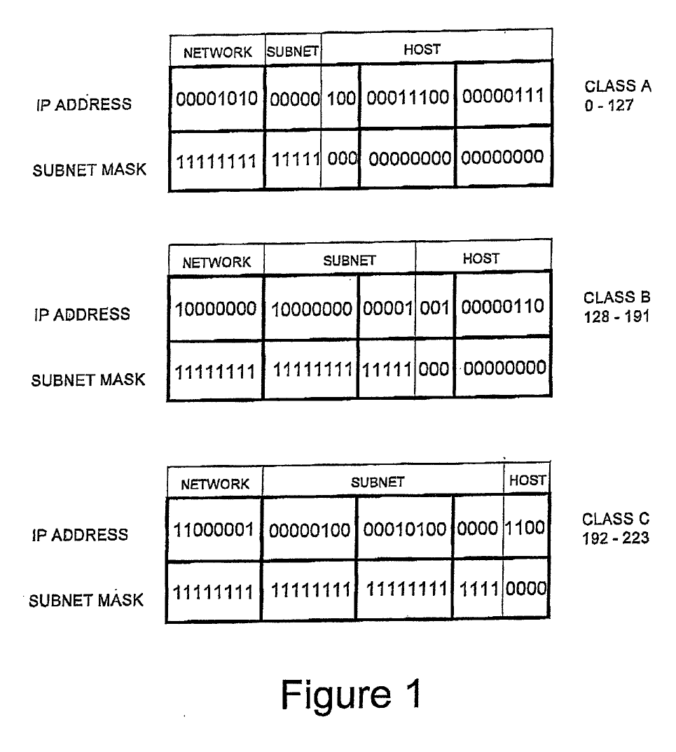

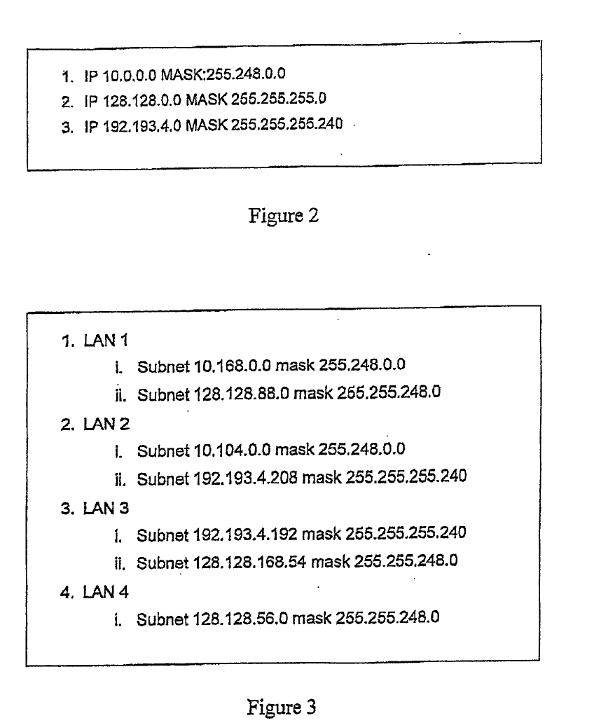

### DETAILED DESCRIPTION OF THE INVENTION

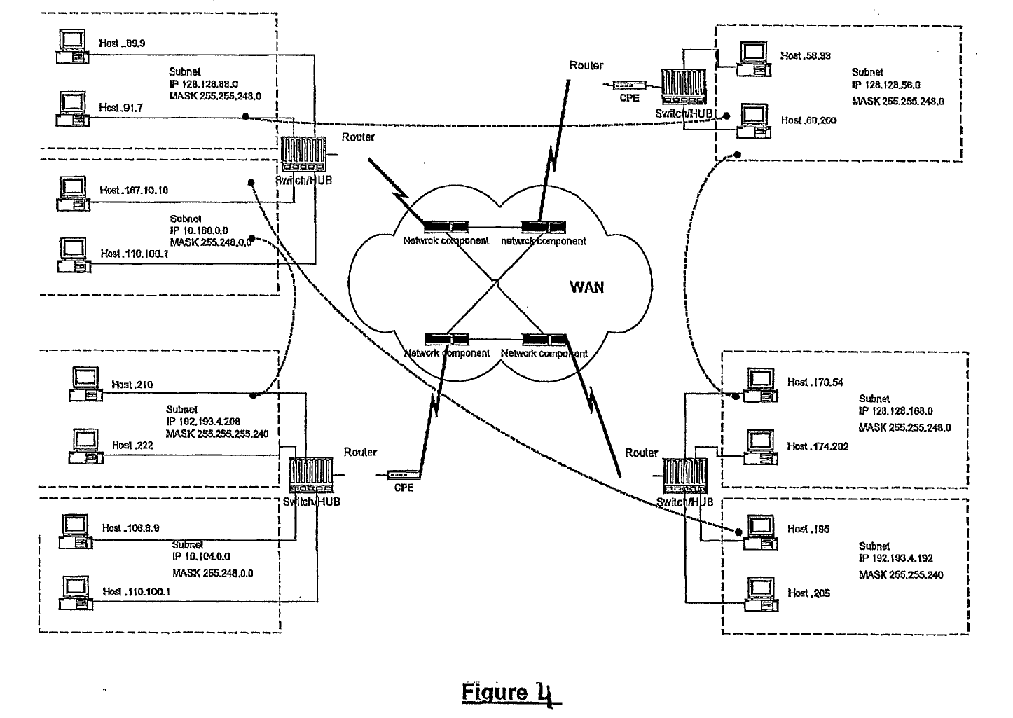

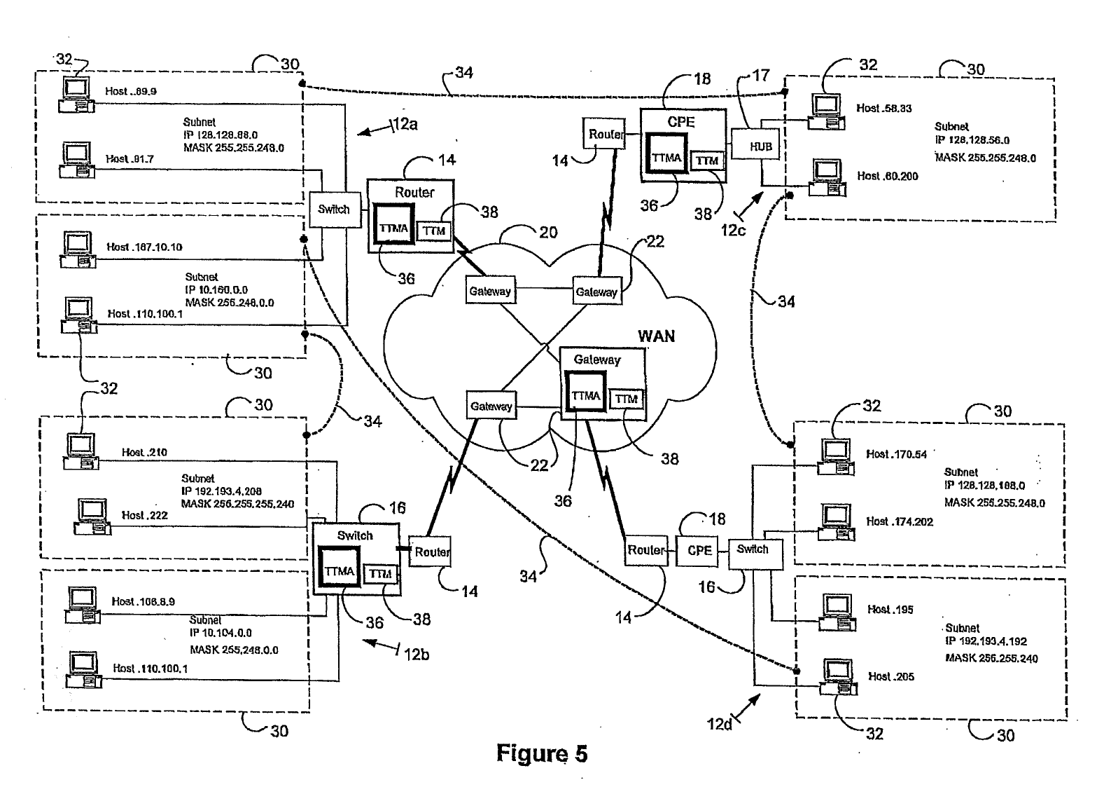

The method of the invention, named Traffic Flow topology Mapping (TFTM), will now be explained with reference to FIG. 5, which shows the exemplary organizational net of FIG. 4 modified according to the invention. The method is typically carried out at each of a plurality of sites of the organization, in cooperation with the others, where a site is characterized by a local area network (LAN) 12a-12d that is connected to a wide-area network (WAN) 20 trough some gateway, usually—a router 14. Also centrally connected to each LAN, in series with router 14, is a switch 16 or hub 17 and optionally—one or more components s generally called Customer Premises Equipment (CPE) 18. Within the WAN, there is at least one component, such as a switch, for each LAN, to serve as a gateway 22. Any of the above-mentioned components will be generally referred to as a network component. It is noted that at any geographical site (e.g. town, campus, building), there may be a plurality of LANs 12, but in the present context, we shall regard each LAN as being in a site by itself. Also, as noted, several LANs (at a common site or at different sites) may be connected to the same gateway 22. To each LAN are connected a plurality of hosts 32, where the term host is understood to include any terminal digital equipment such as a personal computer, a workstation, a server, a stand-alone storage device, a printer, etc. All hosts 32 are is connected to the corresponding hub or switch 16—either directly or through additional switches or bridges (not shown).

As discussed above, hosts at any one site are logically grouped into subnets, represented in FIG. 5 by dashed rectangles 30. Each subnet 30 has been assigned a unique IP subnet address and a mask (which defines the extent of the whole network portion of the address). Exemplary values of these are shown within the rectangle of each subnet 30. The complete IP address of each host 32 then consists of its respective subnet address and the host field. Exemplary values of the latter are shown next to each host. Finally, there are shown in FIG. 5, dotted lines 34 that connect between certain pairs of subnets 30; these represent exemplary corresponding tunnels.

For each site the method is carried out by a Traffic Topology Mapping Agent (TTMA) 36, constituting or residing at a network component through which all message traffic between the local network and the remote networks flows; such a component may be part of a LAN of that site or may be a suitable component within the WAN. In the preferred embodiment, it is a CPE on the link between the LAN and the WAN and this is exemplified in FIG. 5 by CPE 18 that is connected to LAN 12c; optionally this is a dedicated CPE. FIG. 5 shows, however, in connection with other LANs and for illustration purposes, also other configurations for inserting the TTMA into the tic path of such a LAN. Thus, for example, in LAN 12a TTMA 36 is in router 14, in LAN 12b it is in switch (or hub) 16 and for LAN 12d it is in the corresponding WAN component 22 (which would usually be a gateway). In the latter configuration, if component 22 carries all the outside traffic of each of a number of LANs (which, as noted above, is a possible situation, though not shown in the example of FIG. 5), it may include a TTMA for each LAN or, optionally, there may be a single TTMA within it that serves all these LANs, compiling a TTM for each of them. In either case, the traffic to or from any one LAN is preferably distinguished by the port through which it flows out or into the component. In the discussion that follows, each TTMA is assumed to be associated with one LAN; for the case of a TTMA serving multiple LANs, tile method may be modified in an obvious manner.

The goal of “TMA 36 at any site is to automatically compile and maintain an organizational Traffic Topology Map (TTM) 38, which is a table, with entries for each subnet assigned to, and actively used by, any host at the site, (such subnet being termed an active local subnet); each entry lists the local subnet's address, as well as the address of a remote subnet with which it actively communicates; preferably it also lists the IP address of the TTMA associated with that remote subnet. Each entry in the TTM thus defines an active IP tunnel within the organization. Optionally an entry also lists any service to be applied to the tunnel or to any packet flowing therethrough. The TTM, which is copyable into any other component of the network, subsequently serves to classify data packets as to their tunnels and to accordingly monitor and possibly control their flow (including compiling traffic statistics) or to apply an appropriate service to the packet. Optionally, these functions are packaged with the QUA. It is noted that certain complex LANs may have multiple connections to the WAN, whereby traffic to/from particular local subnets may flow through respective edge routers and gateways; in each such case, a tunnel is defined in terms of the particular physical path and, in the context of the invention and of the present discussion, the LAN is considered to be logically split into particular LANs, each corresponding to one of the paths and including the corresponding subnets; the invention and the present discussion is then aimed at any such particular LAN.

The discussion herein assumes all tunnels to be symmetrical (as they indeed usually are), that is—the same rules and services apply to packets flowing in both directions; for cases that any tunnels are not symmetrical, the method can be readily extended, whereby relevant entries each have two indices or service-related fields—one for each direction.

The method logically entails two phases: (1) tracking of traffic to and from local subnets, to generate entries in the table; (2) exchanging address information with remote sites, to mutually fill in the entries with map data. Operation is automatic, except that some external data input may be required to fill in the is information about services to be applied; such input may come from a human operator or from a suitable computer process. At system startup, the table is initially blank, so that entries will first be generated at a fast rate. When, however, some steady state is reached, the TTMA will, in effect, act in a maintenance mode, whereby only newly formed (and thus newly detected) tunnels will be entered; optionally, entries are deleted after some given lifetime.

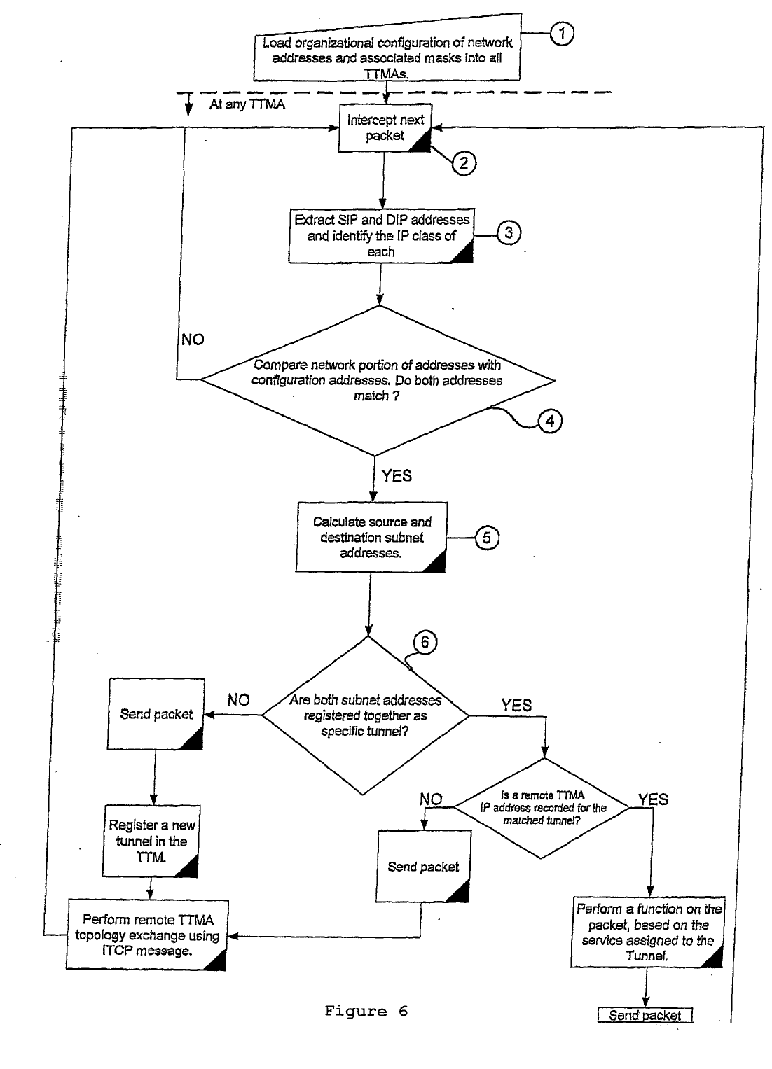

Operation of a TTMA according to the invented TFTM method is summarized in the flow chart of FIG. 6; steps therein are marked by numerals, referenced in the sequel. Preliminarily (step 1), the address configuration (i.e. the list of all the IP network addresses assigned to the organization, with their respective masks) are loaded into the TTMA. It is recalled from the Background section that these assigned addresses may be of any of the three classes, and that each mask indicates, in addition to the network field, the extent of the subnet field in the respective address. It is noted, as a major feature of the invention, that in contrast with conventional systems, where it is required to supply to each local net a list of the network- and subnet addresses assigned to it (the compilation and maintenance of which list is a tedious task, as pointed out in the Background section), the method of the invention requires loading only this overall configuration list—identically to all TTMAs in the organizational net.

During tile first phase of operation, the TTMA intercepts (step 2) each data packet flowing into, or out of, the local net, at IP layer 3, and extracts (step 3) from it the Source IP address (SIP) and the Destination IP address (DIP). Each such address is first decoded, by looking at the first one of its four constituent bytes and determining therefrom the class of the address. The TTMA next looks at the network address field (which may include the first one, two or three bytes of the address, depending on the determined class) and compares it (step 4) with the stored network addresses (i.e. those assigned to the organization) of the corresponding class. If the network fields of both the SIP and the DIP addresses match, the packet is determined to flow within the organization and the process continues; otherwise, the packet is considered to belong to external traffic and is sent on without further processing. The MA then applies to each SIP and DIP a mask corresponding to its network address and thus extracts (step 5) the full subnet address (i.e. the subnet portion of the full address, which includes the network field and the subnet field). It is noted that host address fields are thus disregarded. Finally, the extracted subnet addresses are compared with those already registered in the TTM (step 6); if an identical pair of addresses does not exist they are copied into a new entry in the table of the TTM and thus registered (step 9) as a new tunnel. The entry is recorded preferably in tie following manner: The subnet address of an outgoing SIP or an incoming DIP is recorded in the first field of an entry (first column), while the subnet address of an outgoing DIP or an incoming SIP is recorded in the second field of the same entry (second column).

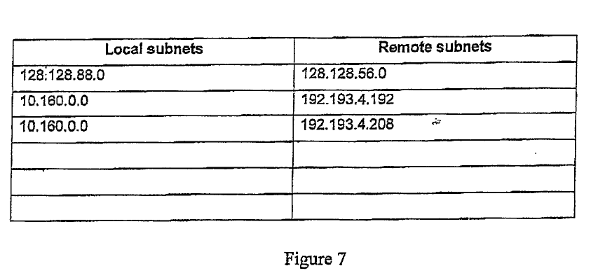

There are thus compiled entries in the TIM table, consisting of the addresses of pairs of subnets, between which traffic has been detected, the first subnet of each pair belonging to the local net and the second subnet belonging to some remote site of the organization, the site being as yet unidentified. Each entry constitutes a tunnel. Optionally another field (column) serves for a running index, identifying the tunnel. An example of a compiled TIM table after first-phase operation is shown in FIG. 7; this example corresponds to the system of FIG. 5 and shows the TTM that would be stored at the LAN marked 12a. It is observed tat any recorded address may have a null subnet field (indicating that the corresponding group of hosts has been assigned a fall network address that has not been subnetted); this will not affect the characterization of the tunnels thus detected and registered. It is also noted that the table is constructed in terms of subnet addresses (and correspondingly defined tunnels), rather than site- or LAN identities as in prior art systems; this is a refinement which is difficult to achieve in conventional systems, where usually only LAN-to-LAN tunnels are configured. If, however, only LAN-to-LAN tunnels (e.g. in terms of assigned services) are to be configured with the invented method, the TTM table may obviously be organized accordingly.

In certain configurations of the LAN gateway (such as a switch) it is important to know also the local layer-2 routing in order to completely characterize a tunnel. For such cases, the TTMA is preferably also operative to extract, for any intercepted package, the corresponding layer-2 identifier and to record it in an appropriate additional field of the tunnel entry in the TTM. Such an identifier would typically be a virtual circuit identifier (e.g. DLCI in a Frame Relay system or VCI/VPI in an ATM system). In some cases it is additionally necessary to identify and record also the physical route, i.e. layer-1 information. This is optionally also done by the TTMA recording a physical route identity in a yet additional field of each tunnel entry in the TTM.

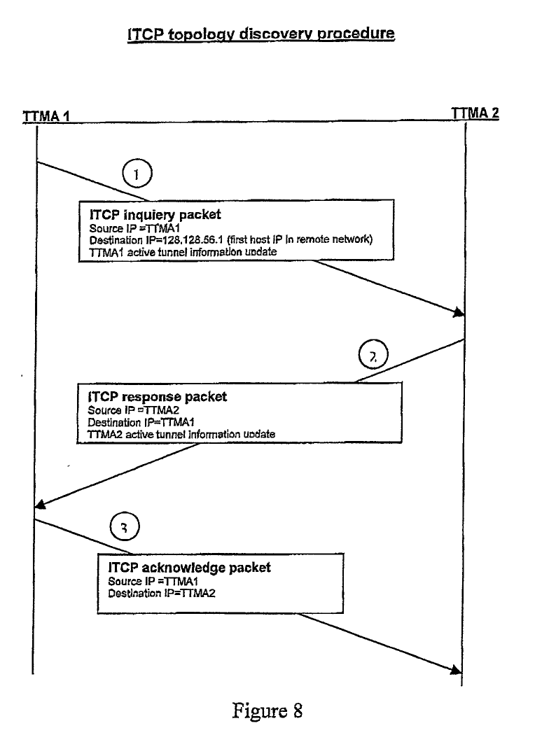

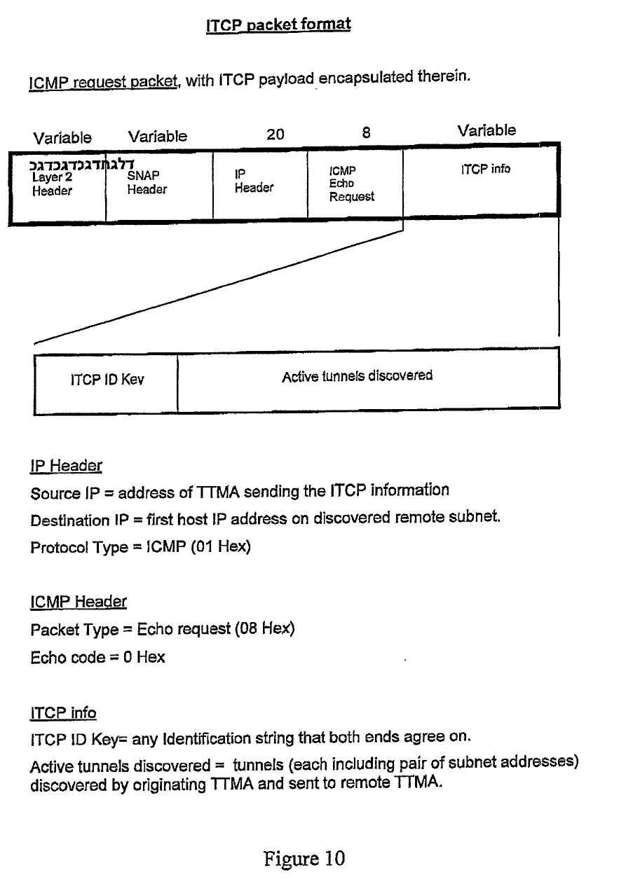

The second phase of operation (step 10 in FIG. 6) is schematically depicted in the diagram of FIG. 8. During this phase, which it initiates periodically or after a new entry in the first phase, the TTMA exchanges topological information with its counterpart at one or more remote sites, using a special message format, termed IP Tunnel Control Protocol (ITCP). An ITCP message (to be referred to as ITCP, for short) consists of a header which includes an identification field, and a variable-length information field; the latter preferably consists of a list of the local subnet addresses, as compiled during the first phase and listed in the first column of the TM table. It is preferably sent as an IP layer-4 message according to the Internet Control Message Protocol (ICMP), with the ICMP header including an echo request, the format of the combination is shown in FIG. 10.

The initiating TTMA (also referred to as the local TTMA) sends (path 1 of FIG. 8) an ITCP inquiry message preferably to each remote subnet that is listed in the second column of the TTM table (as compiled during the first phase) and for which no remote LAN address has yet been registered. Alternatively, it may be sent only to a newly discovered remote subnet The source address is that of the initiating TTMA and the destination address is that of the remote subnet, with the host address being any, for example—the first in the range of host addresses for the corresponding remote subnet. The TTMA at the remote site (to be referred to as the remote TTMA) intercepts the ICMP packet, and notes the address of the initiating TTMA and of the destination subnet and extracts the ITCP information, recognizing it as such by its ID header. Next, it compares the subnet addresses embedded therein with those already recorded in the second column of its own TTM (to be referred to as the remote TTM); it is assumed that the recorded information has been compiled by the remote TTMA in a first-phase operation, as described above. For each positive result of the comparison, the IP address of the initiating TTMA is entered in the third field of the respective tunnel entry in the remote TTM (third column of the table), i.e. in association with the respective subnet address. It is noted that the entries thus affected need not be only those associated with the local subnet (recorded in the first column) that was addressed by the ITCP packet (as destination address), but may also be associated with other local subnets that form tunnels with subnets in the initiating site (as listed in the received ITCP). In the case that a complete topology map is desired (whereby all possible connections are listed, not only those with active traffic), the comparison step is skipped and all the received subnet addresses are entered into the remote TTM, in association with the received TTMA address.

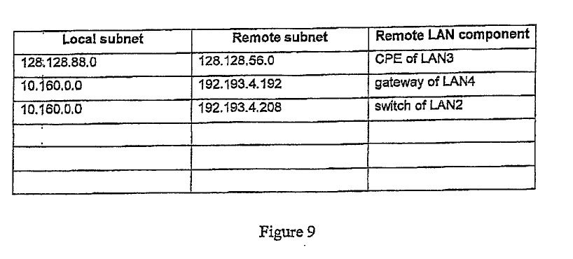

The remote TTMA then preferably sends (path 2 of FIG. 8) to the initiating TTMA an ITCP response message that lists the subnets active in its own LAN, as detected in its own first phase of operation. This is done by means of ICMP in a manner similar to that described above, except that the destination address is now preferably the IP address of the initiating TTMA (which is now known to the responding TTMA). The initiating TTMA, upon reception of the response message, uses the address of the responding remote TTMA and the enclosed list of subnet addresses, respectively, to fill in the third column and to supplement its own TTM table—similarly to what has been described above. The appearance of the TTM table associated with the TTMA of LAN1 (12a in FIG. 5) after the operation described above is shown in FIG. 9, where the third column lists identities of remote sites in terms of the identities (which would, in reality, appear as corresponding addresses) of network components in which the TTMAs that are involved with the respective tunnels reside. Finally, the initiating TTMA issues an acknowledge message to the responding TTMA (path 3 in FIG. 7).

The process, described above, of exchanging subnet topology information between TTMAs is naturally repeated among many pairs of TTMAs (and their respective local nets), possibly just those between which there is any active traffic; in this manner, TTMs in all of them are rapidly completed. Moreover, the procedure is also repeated when new subnets or new tunnels are discovered at any site; in this manner; information in the TTMs is reliably maintained up-to-date. It is further noted that the entire procedure, in both its phases, is entirely automatic and does not require any operator intervention nor any additional inputs, such as externally supplied information on net topology and configuration (except for the network address configuration for the entire organization, which is initially loaded identically into all TTMAs, as indicated above, and need be reloaded only if there is a change in them).

The TTM has been described above, and illustrated in the drawings, as a table, which would be embodied in a conventional manner in a digital memory. While this remains a practical possibility, the preferred embodiment has the TTM formatted as a Management Information Base (MIB), commonly known in the art or in any other format that allows the TTM to readily exchange its contents with authorized other network components and, in particular, have any authorized agent within such a component retrieve any of the data stored in the TTM. This is important for agents and components that, for example, provide tunnel-related services and those that otherwise monitor the activities in the net. It is appreciated that, while tunnel entries preferably consist of pairs of subnet addresses, the TTM data may also be organized in any different manner, for example—so that each local subnet address and/or each remote subnet address appears only once.

Optionally, the TTM table may be made to include entries for all possible combinations of local and remote subnet addresses ever detected, not only those pairs for which traffic has been detected. Although such an option may be deemed to be generally impractical, because for large organizations the size of the table would be unwieldy and, more importantly, it would be tedious and actually unnecessary to fill in the associated information, such as relevant services, compiling entries in the TTM may be carried out by the method outlined above, with minor modifications,

The remote TTMA addresses, recorded in each TTM in association with tunnels, may serve: to identify the corresponding remote site or LAN—for various possible purposes. The main purpose relates to the primary reason for defining tunnels, namely assigning them suitable services, as mentioned in the Background section. Such services may be of two types—active and passive. Active services are those that involve some processing or manipulation of traffic packets and include, for example: data compression, data encryption, bandwidth management and MPLS tagging. Passive services are those that relate primarily to the path and do not alter the traffic packets; they include, for example, the measurement of certain parameters related to service level agreements, such as percentage availability response time, packet drops and throughput rate.

These services are usually provided by suitable hardware- or software components, such as various CPAs, in the network. To this end, mapping and tunnels information is copied from the TTM into the relevant components, whereby suitable services are assigned to the tunnels. In an optional configuration of the present invention, a TTMA itself associates tunnels with their assigned services preferably by listing the latter in a fourth column of the TM table; such an augmented table would then be copied into the relevant service-providing components. In a further optional configuration, the TTMA may be associated with one or more of the services, by being packaged with one or more modules that provide such services or by sharing the network component in which it resides with such modules. In any case, assigning the services to tunnels may have to be done by an operator, on the basis of organizational practices. Alternatively, the assignment of services to tunnels may be according to some default parameters or carried out by a suitable computer program or agent, on the basis of given rules and some data about the; relation of certain subnets to the organization. In both of these cases, the TTMA may provide a suitable interface.

Another optional feature of the TTMA, or associated with it, foreseen by the invention is the carrying out of routine packet classification. Packet classification is part of any operation within the network that utilizes the TTM information in order to treat data packets differentially, for example—in providing any of the services, in controlling the traffic or in compiling traffic statistics. Functions of the TTMA may be expanded to provide routine classification, as follows (with reference to FIG. 6): The TTMA simply intercepts every packet (outgoing or incoming or both) and calculates source- and destination subnet addresses, in much the same way as during the first phase of its TFTM operation, as described above. It then compares (step 6) the two addresses with corresponding columns in the TTM table, to find a matching entry. If a match is found, the TTMA then looks (step 7) for the corresponding required parameter, such as the remote site identity or the tunnel index. In the optional case (per above) that the table also includes the assigned services, the identities of the corresponding services are provided. This identity is conveyed to the appropriate service providing agent, which performs the service (step 8) with respect to the intercepted package. Clearly, if the TTMA resides in a CPE that also carries out any such services, the information may be used directly to activate the service on the current (intercepted) data packet. Preferably, the first phase of the TTM compilation and the routine classification are integrated, whereby the source- and destination subnet addresses are calculated for each packet and compared with subnet addresses registered in the TTM, as described above, if a match is found, operation proceeds as classification; if no match is found, operation proceeds as compilation of a new tunnel—all as described above and illustrated in FIG. 6.

Many tunnel-related services, such as encryption, compression and response time measurement, involve operations at both ends of the tunnel, i.e. at some component associated with the sending LAN and at some component associated with the receiving LAN. Therefore some communication between such pairs of network components is required—for coordination or for exchange of parameters or data. It is mainly for His reason that the identity of the remote sites must be known and registered at each TTM for each tunnel In the preferred embodiment of the invention this identity is in the form of the IP addresses of the respective remote TTMAs, which has the advantage of directly providing a path for such communication. So this end, a TTMA has optionally the function of actually exchanging required parameters or data—either on demand or periodically; such an exchange is preferably carried out using the ITCP, explained above. If a TTMA is configured to provide the service, or to be an intermediary thereto (as described above), it will process the transmitted data or parameters; else it will forward them to the proper local component.

It is to be understood that all reference to subnets in the discussion herein apply also to cases in which any organizational subnet is assigned a full IP network address without IP subnetting, as well as to cases in which there is only one such subnet at any LAN or site. It is also to be understood that the term CPE in the discussion herein refers to any network component such as a switch or a router, through which IP data traffic passes, whether in a local network or within a wide-area network; in the latter case, however, such a component must be logically associated with a particular LAN or site.

A TTMA, as specified herein, may be realized as a software program loaded into a general-purpose digital processor in a network component, or as a special-purpose processor in such a component, or as stand-alone network component. In any such form it may be packaged with modules serving other functions, or, alternatively, have itself some extended functionality. In particular, such additional functionalities may include the function of packet classification (as described above) and of providing certain ones of the mentioned services, such as compression, encryption and service level agreement monitoring.

The present invention has been described above in terms of certain preferred embodiments. It should be understood, however, that such embodiments serve only to illustrate the concept of the invention, not to limit its scope and that many other embodiments and configurations are possible by modification of what has been described—all corning within the scope of the inventive concept and of the claims that follow. In Vie method claims, alphabetic characters used to designate claim steps are provided for convenience only and do not imply any particular order of performing the steps.

1. In an organizational communication net based on the Internet Protocol (P) and deployed offer a plurality of Local-Area Networks (LANs) that are interconnected by a Wide-Area Network (WAN); each LAN is associated with at least one IP LAN address and connected to at least one host, the hosts being grouped into one or more subnets, each subnet sharing a unique network- or subnet address, which is within the range of a given organization-wide network address configuration; the communication path between any host having any particular subnet address and any host having any other particular subnet address and connected to a different LAN is termed a tunnel—
a method for automatically compiling a dynamic traffic topology map (TTM) for each of a plurality of LANs, the method comprising the following steps executed with respect to any one of said LANs, constituting a local LAN:
(a) automatically detecting the respective subnet addresses of a local host and of a remote host between which any data packets flow, the addresses being a local subnet address and a remote subnet address, respectively;
(b) automatically obtaining a LAN address of a remote LAN that is connected to the host having said remote subnet address and associating the obtained LAN address with said remote subnet address;
(c) registering a tunnel for the combination of said local subnet address and said remote subnet address, if not presently registered, the registration including recording the local and remote subnet addresses and the remote LAN address obtained in step b;
(d) repeating steps a, b and c multiple times; the totality of registered tunnels form the TTM.

2. The method of claim 1, wherein step a includes:
(i) intercepting any of said packets and parsing it into a source IP address (SIP) and a destination IP address (DIP);
(ii) comparing each of said addresses of step 1 with said given organization-wide address configuration and thereby extracting a corresponding subnet address;
(iii) if the intercepted packet is outgoing, recording the subnet address extracted from the SIP as a local subnet address and that extracted from the DIP—as a remote subnet address; and if the intercepted packet is incoming, recording the subnet address extracted from the DIP as a local subnet address and that extracted from the SIP—as a remote subnet address.

3. The method of claim 2, wherein substep i includes extracting from the intercepted packet also layer-2 encapsulation mapping, is step b includes associating also the extracted layer-2 encapsulation mapping with said remote subnet address, and in step c said registration also includes recording the associated layer-2 encapsulation mapping.

4. The method of claim 1, wherein step b includes:
(iv) sending from a network component associated with the local LAN, constituting a local component, an inquiry message addressed to any host having said remote subnet address, the message including a local LAN address, which is the LAN address of said local component;
(v) intercepting said inquiry message by a network component associated with the LAN to which said any host is connected, it being a remote component, and extracting said local LAN address from said inquiry message;
(vi) sending a response message from said remote component, addressed to said local component and including a remote LAN address, which is the LAN address of said remote component;
(vii) receiving said response message at said local component and extracting therefrom said remote LAN address.

5. The method of claim 4, wherein said inquiry message also includes one or more local subnet addresses and substep v further includes having said local subnet addresses extracted from the intercepted message and associated with the extracted local LAN address.

6. The method of claim 4, wherein said response message also includes one or more remote subnet addresses and substep vii further includes having said remote subnet addresses extracted from the received message and associated with the extracted remote LAN address.

7. The method of claim 45 wherein all steps of the method are performed at each of said network components by an agent residing therein and wherein a plurality of said agents cooperate in performing any of the steps.

8. The method of claim 1, wherein the only data input from outside the system is said address configuration, the data being identically fed with respect to all LANs within the net.

9. The method of claim 1, further including identifying each registered tunnel with a unique index.

10. The method of claim 1, further including transmitting any of the registered tunnel data to any other network component.

11. The method of claim 10, wherein said any other component is operative to provide one or more services to any tunnel or to data packets flowing through it

12. The method of claim 1, further including: associating with each registered tunnel one or more specific services applicable to it or to data packets flowing through it.

13. The method of claim 12, further including: recording in any entry in the TTM the identities of services associated with the corresponding tunnel.

14. The method of claim 12, further including: periodically or upon command, applying to any registered tunnel any of its associated services that is applicable to it.

15. The method of claim 12, further including: classifying each packet flowing in or out of a LAN as to the tunnel in which it flows and applying to the packet any of the services that are associated with that tunnel.

16. The method of claim 1, further including: deleting from the TTM any tunnel through which no data packets have flowed over a preceding period of a given duration.

17. The method of claim 1, wherein the TIM is in a format that allows data stored therein to be retrieved by any authorized agent in the net.

18. For an organizational communication net, based on the Internet Protocol (IP) and deployed over a plurality of Local-Area Networks (LANs) that are interconnected by a Wide-Area Network (WAN); each LAN is associated with at least one IP LAN address and connected to at least one host, the hosts being grouped into one or more subnets, each subnet sharing a unique network- or subnet address, which is within the range of a given organization-wide network address configuration; the communication path between any host having any particular subnet address and any host having any other particular subnet address and connected to a different LAN constitutes a tunnel and, furthermore, a tunnel over which any data packets have flowed over a given period of time constitutes an active tunnel—
a network component, connected to, or communicative with, any one or more of the LANs, each constituting a local LAN, the network component comprising a traffic topology mapping agent (TTMA) and one or more traffic topology maps (TTM), each TTM associated with a respective local LAN, wherein:
each TTM is a table structured as indexed entries, each entry corresponding to an active tunnel and including a local subnet address, a remote subnet address and a remote LAN address with which said remote subnet address is associated; and
the TTMA is a network agent operative to register active tunnels in each of said TTMs and, with respect to any of said tunnels to be registered, to—
automatically detect a subnet address of any host connected to the corresponding local LAN and a subnet address of any host connected to any other LAN, between which hosts any data packets flow, and record the two detected addresses in the respective entry of the corresponding TTM, as the local subnet address and the remote subnet address, respectively; and—
automatically obtain a LAN address associated with said other LAN and record the obtained LAN address in the respective entry of the corresponding TTM.

19. The network component of claim 18, wherein detecting subnet addresses includes:
intercepting any of said data packets and parsing it into a source IP address (SIP) and a destination IP address (DIP); and
comparing each of said pair of addresses with said given organization-wide address configuration and thereby extracting a corresponding subnet address;

20. The network component of claim 18, wherein said obtaining a LAN address includes:
sending an inquiry message addressed to any host having said remote subnet address, the message including a LAN address of the respective local LAN; and
receiving a response message, containing a LAN address associated with said other LAN, and extracting said LAN address from said response message.

21. The network component of claim 20, wherein the TTMA is further operative to automatically—
intercept an inquiry message addressed to a host connected to any local LAN, the message including the LAN address of any other LAN, and extract said address from the message; and
send a response message, addressed to said other LAN and including the LAN address of said local LAN.

22. The network component of claim 18, wherein each TTM is in a format that allows data stored therein to be retrieved by any authorized agent in the net

23. For use in he network component of claim 18, a traffic topology mapping agent (COMA), operative to register active tunnels in any of said TTMs and, with respect to any of said tunnels to be registered, to—
automatically detect a subnet address of any host connected to the corresponding local LAN and a subnet address of any host connected to any other LAN, between which hosts any data packets flow, and record the two detected addresses in the respective entry of said any TTM, as the local subnet address and the remote subnet address, respectively; and—
automatically obtain a LAN address associated with said other LAN and record the obtained LAN address in the respective entry of said any TTM.

24. In an organizational communication net, deployed over a plurality of Local-Area Networks (LANs) that are interconnected by a Wide-Area Network (WAN); each LAN is associated with at least one IP LAN address and connected to at least one host, the hosts being grouped into one or more subnets, each subnet sharing a unique network address, termed subnet address, which is within the range of a given organization-wide network address configuration; the communication path between any particular subnet at any one LAN and any particular subnet at another LAN is termed a tunnel—
a method for classifying, by tunnels, IP data packets flowing into and/or out of any one LAN, to be considered a local LAN, from and/or to other LANs, to be considered remote LANs, the method comprising:
(a) providing structure for a traffic topology map (TTM), associated with the local LAN, in which tunnels may be registered, the structure including an entry corresponding to each registered tunnel, each entry including a local subnet address, which is the address of a subnet in the local LAN, and a remote subnet address, which is the address of a subnet in the remote LAN;
(b) intercepting any of said packets and extracting therefrom a local subnet address and a remote subnet address;
(c) comparing said extracted pair of addresses with corresponding pairs in any tunnels registered in the TTM;
(d) if said comparison results in a match, associating the packet with the corresponding tunnel;
(e) if said comparison results in no match, registering said extracted pair in the TTM as a new tunnel.

25. The method of claim 24, wherein step b includes:
(i) parsing the intercepted packet into a source IP address (SIP) and a destination IP address (DIP);
(ii) comparing each of said addresses of substep i with said given organization-wide address configuration and thereby extracting a corresponding subnet address;
(iii) if the intercepted packet is outgoing, regarding the subnet address extracted from the SIP as a local subnet address and that extracted from the DIP—as a remote subnet address; and if the intercepted packet is incoming, regarding the subnet address extracted from the DIP as a local subnet address and that extracted from the SIP—as a remote subnet address.

26. The method of claim 24, fewer comprising:
(f) for any registered tunnel, automatically obtaining a LAN address associated with a remote LAN that corresponds to the respective remote subnet address and recording the obtained LAN address in association with the tunnel.

27. The method of claim 26, wherein in step f said obtaining includes:
(iv) sending an inquiry message addressed to any host having said remote subnet address, the message including a local LAN address;
(v) having said inquiry message intercepted and having said local LAN address extracted therefrom;
(vi) sending a response message, addressed to said local LAN address and including a remote LAN address;
(vii) receiving said response message and extracting therefrom said remote LAN address.

28. The method of claim 24, further including identifying each registered tunnel with a unique index and wherein step d further includes transmitting the index identifying said tunnel to any component or agent associated with the local LAN.

29. Be method of claim 24, further including: associating with each registered tunnel one or more: services applicable to it or to data packets flowing through it and wherein step d further includes applying to the packet any service associated with said tunnel.

30. At a Local-Area Network (LAN) that forms part of an organizational communication net, based on the Internet Protocol (IP), and is connected to at least one host, the hosts being grouped into one or more subnets, each subnet sharing a unique network address, to be termed subnet address, which is within the range of a given organization-wide IP network address configuration—
a method for automatically registering local subnets, based on communication traffic into and/or out of the LAN, the method comprising:
(a) intercepting a packet flowing into, or out of, the LAN and parsing it into a source IP address (SIP) and a destination IP address (DIP);
(b) comparing each of said addresses of step a with said given organization-wide address configuration and thereby extracting a corresponding subnet address;
(c) if said intercepted packet is outgoing, recording the subnet address extracted from the SIP as a local subnet address and if said intercepted packet is incoming, recording the subnet address extracted from the DIP as a local subnet address.

31. In an organizational communication net, based on the Internet Protocol (IP) and deployed over a plurality of Local-Area Networks (LANs) that are interconnected by a Wide-Area Network (WAN); each LAN is associated with at least one IP LAN address and is connected to at least one host, the hosts being grouped into one or more subnets, each subnet sharing a pique network address, to be termed subnet address; there are registered in association with any LAN, constituting a local LAN, one or more remote subnet addresses, which are addresses of respective subnets in other LANs, constituting remote LANs—
a method for automatically obtaining, for any remote subnet address registered in association with a local LAN, a LAN address associated with the remote LAN that is connected to the respective subnet, the obtained address to be associated with said registered subnet address, the method comprising:
(a) sending from a network component associated with the local LAN, constituting a local component, an inquiry message addressed to any host having said remote subnet address, the message including a local LAN address, which is the LAN address of said local component;
(b) intercepting said inquiry message by a network component associated with the LAN to which said any host is connected, it being a remote component, and extracting said local LAN address from said inquiry message;
(c) sending a response message from said remote component, addressed to said local component and including a remote LAN address, which is the LAN address of said remote component;
(d) receiving said response message at the local component and extracting therefrom said remote LAN address.

32. In an organizational communication net, based on the Internet Protocol (IP) and deployed over a plurality of Local-Area Networks (LANs) that are interconnected by a Wide-Area Network (WAN); each LAN is connected to at least one host, the hosts being grouped into one or more subnets, each subnet sharing a unique network- or subnet address, which is within the range of a given organization-wide network address configuration; the communication path between any host having any particular subnet address and any host having any other particular subnet address and connected to a different LAN is termed a tunnel a method for automatically compiling, with respect to any LAN, considered as a local LAN, a traffic topology map (TTM) of active tunnels between local hosts, connected to the local LAN, and remote hosts, connected to remote LANs, the method comprising,:
(d) automatically detecting a subnet addresses of any local host and of any remote host between which any data packet flows, the addresses being a local subnet address and a remote subnet address, respectively;
(e) registering a tunnel for the combination of a local subnet address and a remote subnet address detected in step a, if not presently registered;
(f) repeating steps a and b multiple times; the totality of registered tunnels form the TTM.

33. The method of claim 32, wherein step a includes:
(i) intercepting a packet flowing out of, or into, the local LAN and parsing it into a source IP address (SIP) and a destination IP address (DIP);
(ii) comparing each of said addresses of step i with said given organization-wide address configuration and thereby extracting a corresponding subnet address;
(iii) if said intercepted packet is outgoing, recording the subnet address extracted from the SIP as a local subnet address and that extracted from the DIP—as a remote subnet address; and if said intercepted packet is incoming, recording the subnet address extracted from the DIP as a local subnet address and that extracted from the DIP—as a remote subnet address.

34. The method of claim 32, wherein the only data input from outside the system is said address configuration, the data being identically fed with respect to all LANs within the net.
